(19) United States
(12) Patent Application Publication
(10) Pub. No.: US 2013/0330005 A1
(43) Pub. Date: Dec. 12, 2013

(54) ELECTRONIC DEVICE AND CHARACTER RECOGNITION METHOD FOR RECOGNIZING SEQUENTIAL CODE

(71) Applicants: Hon Hai Precision Industry Co., Ltd., New Taipei (TW); Fu Tai Hua Industry (Shenzhen) Co., Ltd., Shenzhen (CN)

(72) Inventors: XIN LU, Shenzhen (CN); HUAN-HUAN ZHANG, Shenzhen (CN); FEI WANG, Shenzhen (CN); BIAO-GENG ZHONG, Shenzhen (CN); XUE-SHUN LIU, Shenzhen (CN)

(21) Appl. No.: 13/910,220

(22) Filed: Jun. 5, 2013

(30) Foreign Application Priority Data
Jun. 11, 2012 (CN) 201210189910X

(51) Int. Cl. G06K 9/18

(52) U.S. Cl. CPC G06K 9/18
USPC 382/182

(57) ABSTRACT

A character recognition method to apply one or more user-controlled definitions to scanned writing is implemented by an electronic device. The electronic device includes an image capturing device where a recognition rule is set for recognizing a type of a sequential code according to an arrangement rule of characters of the type of sequential codes. A first sequential code is extracted from a captured image of an object having a sequential code and when the first sequential code does not match with the recognition rule, the first sequential code is corrected according to the preset recognition rule to obtain a second sequential code for matching with the recognition rule.

### BACKGROUND

1. Technical Field

The present disclosure relates to character recognition technologies, and more particularly to a character recognition method and an electronic device having a character recognition function.

2. Description of Related Art

Optical character recognition (OCR) technology is used to recognize handwritten, typewritten or printed characters of scanned images, such as recognizing sequential codes of different identity cards. However, when the characters of the scanned images include similarly shaped letters and numbers, for example, “0” and “0”, and “1” and “I”, mistaken recognition may happen during the OCR process, which reduces accuracy of the character recognition. Therefore, there is room for improvement in the art.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views, and all the views are schematic.

FIG. 1 is a block diagram of an electronic device according to an exemplary embodiment of the present disclosure.

FIG. 2 shows a diagram of a user interface provided by the electronic device for setting the recognition rule.

FIG. 3 is a flowchart of one embodiment of a character recognition method of the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

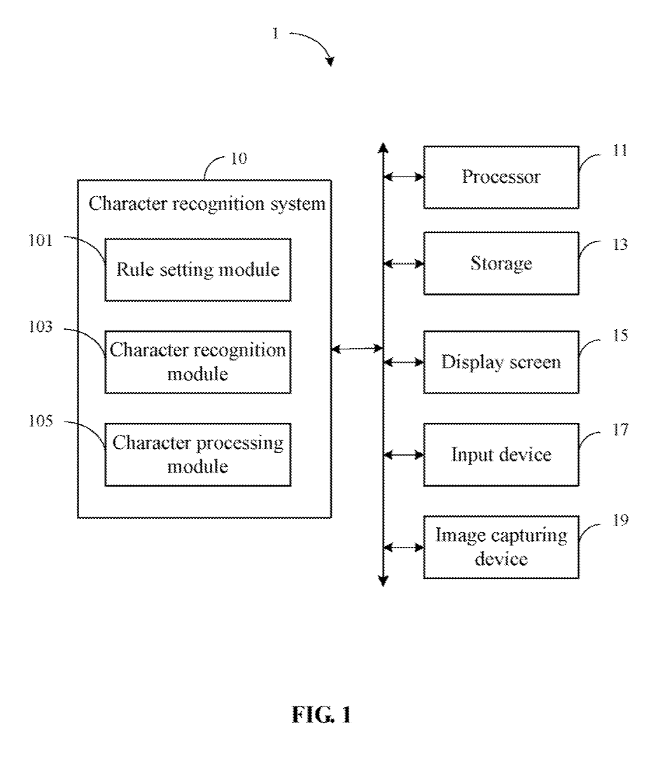

FIG. 1 is a block diagram of an electronic device 1 according to an exemplary embodiment of the present disclosure. The electronic device 1 includes a character recognition system 10, a processor 11, a storage 13, a display screen 15, an input device 17, and an image capturing device 19. In one embodiment, the electronic device 1 may be, for example, a scanner, a laptop computer, a smart phone, or other similar device. In one embodiment, the input device 17 may be, for example, a keyboard. The image capturing device 19 may be, for example, a camera or other device capable of capturing images. FIG. 1 shows one example of the electronic device 1, and the electronic device 1 can include more or fewer components than those shown in the embodiment, or have a different configuration of the components.

The character recognition system 10 may include a plurality of programs in the form of one or more computerized instructions stored in the storage 13 and executed by the processor 11 to perform operations of the electronic device 1. The programs of the character recognition system 10 may be embedded in a device driver or an operating system (OS) of the electronic device 1. In one embodiment, as shown in FIG. 1, the character recognition system 10 includes a rule setting module 101, a character recognition module 103 and a character processing module 105. In general, the word “module” as used in here, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The rule setting module 101 sets a recognition rule for recognizing a type of sequential codes according to an arrangement rule of characters (e.g., alphabetic, numeric, alphanumeric) of the type of sequential codes. In the embodiment, the type of sequential codes may be for example, device identity codes of computers manufactured by a factory, which have a particular arrangement rule. The sequential codes include at least one letter and/or at least one number. The recognition rule includes parameters of a total number of characters in the type of sequential codes and a characteristic of each character in the type of sequential code. The characteristic of each character is defined to be alphabetic, numeric, or alphanumeric.

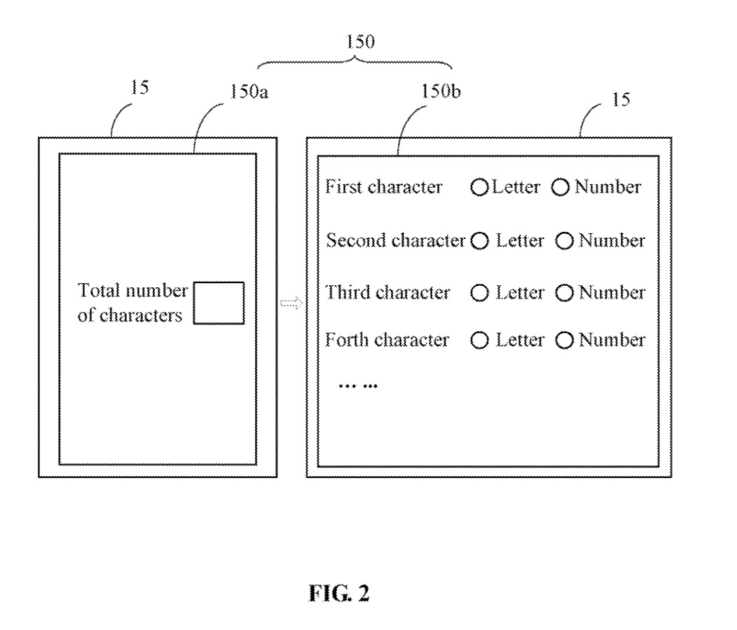

FIG. 2 shows a diagram of a user interface 150 provided by the electronic device 1 for setting the recognition rule. The user interface 150 is displayed on the display screen 15, and the recognition rule is set by the user using the input device 17 through the user interface 150.

The user interface 150 includes a first setting interface 150a and a second setting interface 150b as shown in FIG. 2. The first setting interface 150a is configured to set the total number of characters of the type of sequential codes. The second setting interface 150b is configured to set the characteristic of each character in the type of sequential codes. In one embodiment, the second setting interface 150b displays a pair of options for each character of the type of sequential codes, and the user can select one of the pair of options to set the characteristic of each character. Each character of the type of sequential codes corresponds to a pair of options. In the embodiment, each pair of options includes an option of “number” and an option of “letter”. The recognition rule is composed of the total number of the characters of the sequential codes and the characteristic of each character in the sequential codes. For example, the recognition rule may be “9 characters, the first to fifth characters being numbers, and the sixth to ninth characters being letters.

In the embodiment, a type of sequential codes, namely “CD56423”, “AB25897”, and “BO12345” are taken for an example. Based on this type of sequential codes, the recognition rule may be set as “the total number of characters of the sequential codes is 7, the first and second characters are letters, and the third to seventh characters are numbers”. In this regard, “7” is input through the first setting interface 150a. The characteristic of each character of the sequential codes is input or selected through the second setting interface 150b.

In another embodiment, the first setting interface 150a is a selective control/widget. The selective control/widget provides a plurality of numbers for the user to select, and the selected number is input through the first setting interface 150a according to the selection of the user.

In another embodiment, the display screen 15 is a touch screen, and the independent input device 17 may be omitted. The touch screen is configured to input the parameters of recognition rule.

The character recognition module 103 activates the image capturing device 19 to capture an image of an object having a sequential code and extracts a first sequential code from the captured image using an optical character recognition (OCR) technology. In the embodiment, after the first sequential code is extracted from captured image, the character recognition module 103 temporarily stores the first sequential code into the storage 13. In one embodiment, the first sequential code is stored in the storage 13 in a format of American Standard Code for Information Interchange (ASCII). For example, in the ASCII format, the number “1” is coded in binary as “01101100”, the letter “1” is coded as “01001001”, the number “8” is coded as “00111000,” and the letter “B” is coded as “01000010”.

The image capturing device 19 captures an image of an object having a sequential code and extracts a first sequential code from the captured image using an OCR technology. However, when the characters of the captured images may include similarly shaped letters and numbers, mistaken recognition may happen during the OCR process.

In view of the above, the character processing module 105 determines whether the first sequential code matches with the set recognition rule of the type of sequential codes, and corrects the characters of the first sequential code according to the recognition rule to obtain a second sequential code that does match with the recognition rule when the first sequential code cannot be matched with the recognition rule. Details of correcting of the first sequential code are described below.

The character processing module 105 compares each character of the first sequential code with the recognition rule, and determines whether the characteristic of each character of the first sequential code matches with the recognition rule. If the characteristic of any character of the first sequential code does not match with the recognition rule, the first sequential code is determined to not match with the recognition rule, and the character of the first sequential code is corrected according to the recognition rule. When a character of the first sequential code is a letter, but the corresponding character of the type of sequential codes is a number, the character of the first sequential code is corrected into a predetermined number which is similar shaped with the letter. When a character of the first sequential code is a number, but the corresponding character of the type of sequential code is a letter, the character of the first sequential code is corrected into a predetermined letter which is similarly shaped with the number. For example, if the extracted first sequential code is “8012345”, and the first character of the first sequential code is a number “8”, which characteristic does not match with the recognition rule (which provides that the first and second characters are letters). Then, the first character “8” of the first sequential code is corrected to be a letter “B” which is similarly shaped with the number “8”. Similarly, the second character “0” (zero) of the first sequential code is corrected to a letter “0” which is similarly shaped with the number “0”, for example. After all the characters of the first sequential code are corrected, a second sequential code that matches with the recognition rule is obtained. If the characteristic of each character of the first sequential code matches with the recognition rule, the first sequential code is determined to match as it stands with the recognition rule.

The character processing module 105 further stores the second sequential code into the storage 13 and deletes the first sequential code from the storage 13. In one embodiment, the character processing module 105 further displays the second sequential code on the display screen 15. When the first sequential code matches with the recognition rule, the first sequential code does not need to be corrected and is displayed on the display screen 15. In one embodiment, the second sequential code is also stored in the storage 13 in a format of ASCII.

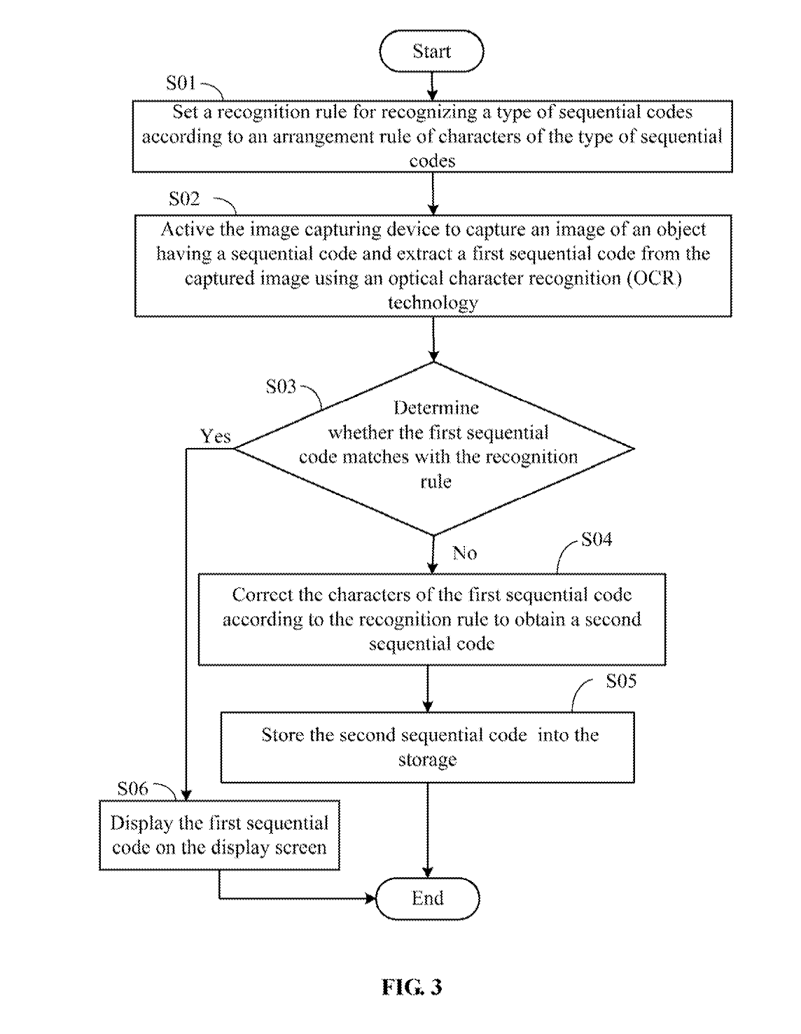

FIG. 3 is a flowchart of one embodiment of a character recognition method of the electronic device of FIG. 1 using the character recognition system 10. Depending on the embodiment, additional steps may be added, others removed, and ordering of the steps may be changed.

In step S01, the rule setting module 101 sets a recognition rule for recognizing a type of sequential codes according to an arrangement rule of characters of the type of sequential codes. The sequential codes include at least one letter and/or at least one number. The recognition rule includes parameters of a total number of characters of each of the sequential codes and a characteristic of each character in the sequential codes. The characteristic of each character is defined to be letter or number.

In step S02, the character recognition module 103 activates the image capturing device 19 to capture an image of an object or document having a sequential code and extracts a first sequential code from the captured image using an optical character recognition (OCR) technology. In the embodiment, after the first sequential code is extracted from captured image, the character recognition module 103 temporarily stores the first sequential code into the storage 13. In one embodiment, the first sequential code is stored in the storage 13 in a format of American Standard Code for Information Interchange (ASCII).

In step S03, the character processing module 105 determines whether the first sequential code matches with the set recognition rule of the type of sequential code. If the first sequential code is determined to not match with the recognition rule of the type of sequential code, step S04 is implemented. Otherwise, the first sequential code is determined to match with the recognition rule of the primary sequential code, and step S06 is implemented. Details of determining whether the first sequential code matches with the set recognition rule of the type of sequential code are provided above.

In step S04, the character processing module 105 corrects the characters of the first sequential code according to the recognition rule to obtain a second sequential code. The correction of the characters is previously detailed in paragraph [0019].

In step S05, the character processing module 105 stores the second sequential code into the storage 13 and deletes the first sequential code from the storage 13. In one embodiment, the character processing module 105 further displays the second sequential code on the display screen 15. When the first sequential code is determined to actually match with the recognition rule, the first sequential code does not need to be corrected, and the first sequential code is displayed on the display screen 15. In one embodiment, the second sequential code is also stored in the storage 13 in a format of ASCII.

In step S06, the character processing module 105 displays the first sequential code on the display screen 15.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A character recognition method for recognizing a type of sequential codes using an electronic device comprising an image capturing device, the character recognition method comprising:
setting a recognition rule for recognizing the type of sequential codes according to an arrangement rule of characters of the type of sequential codes, the characters of the type of sequential codes comprising letters and numbers;
capturing an image of an object having a sequential code using the image capturing device, and extracting a first sequential code from the captured image using optical character recognition technology;
determining whether the first sequential code matches with the recognition rule of the type of sequential codes; and
correcting the characters of the first sequential code according to the recognition to obtain a second sequential code that matches with the recognition rule when the first sequential code is determined to not match with the recognition rule.

2. The character recognition method according to claim 1, further comprising:
storing the first sequential code into a storage of the electronic device.

3. The character recognition method according to claim 2, further comprising:
storing the second sequential code into a storage of the electronic device and deleting the first sequential code from the storage.

4. The character recognition method according to claim 3, wherein the second sequential code is stored in the storage in a format of American Standard Code for Information Interchange.

5. The character recognition method according to claim 1, further comprising:
displaying the second sequential code on a display screen of the electronic device.

6. The character recognition method according to claim 1, wherein the recognition rule comprises parameters of a total number of characters of each of the sequential codes and a characteristic of each character in the type of sequential codes.

7. The character recognition method according to claim 6, wherein the electronic device further comprises a first setting interface and a second setting interface, where the first setting interface is configured to set the total number of the characters of the type of sequential codes, and the second setting interface is configured to set the characteristic of each character of the type of sequential codes.

8. The character recognition method according to claim 1, wherein the determining step comprises:
comparing each character of the first sequential code with the recognition rule to determine whether the first sequential code matches with the recognition rule of the type sequential code.

9. The character recognition method according to claim 8, wherein when the characteristic of each character of the first sequential code matches with the recognition rule, the first sequential code is determined to match with the recognition rule; and when the characteristic of any character of the first sequential code does not match with the recognition rule, the first sequential code is determined to not match with the recognition rule.

10. The character recognition method according to claim 1, wherein when a character of the first sequential code is a letter which does not match with the recognition rule, the letter is corrected into a predetermined number which is similar shaped with the letter;
and when a character of the first sequential code is a number which does not match with the recognition rule, the number is corrected into a predetermined letter which is similar shaped with the number.

11. An electronic device, comprising:
an image capturing device;
a display screen;
an input device;
a processor;
a storage; and
one or more programs stored in the storage and executed by the processor to perform a character recognition method for recognizing a type of sequential codes, the character recognition method comprising:
setting a recognition rule for recognizing the type of sequential codes according to an arrangement rule of characters of the type of sequential codes, the characters of the type of sequential codes comprising letters and numbers;
capturing an image of an object having a sequential code using the image capturing device, and extracting a first sequential code from the captured image using optical character recognition technology;
determining whether the first sequential code matches with the recognition rule of the type of sequential codes; and
correcting the characters of the first sequential code according to the recognition to obtain a second sequential code that matches with the recognition rule when the first sequential code is determined to not match with the recognition rule.

12. The electronic device according to claim 11, wherein the character recognition method further comprises:
storing the first sequential code into the storage of the electronic device.

13. The electronic device according to claim 12, wherein the character recognition method further comprises:
storing the second sequential code into the storage of the electronic device and deleting the first sequential code from the storage.

14. The electronic device according to claim 13, wherein the second sequential code is stored in the storage in a format of American Standard Code for Information Interchange.

15. The electronic device according to claim 11, wherein the character recognition method further comprises:
displaying the second sequential code on a display screen of the electronic device.

16. The electronic device according to claim 11, wherein the recognition rule comprising parameters of a total number of characters of each of the sequential codes and a characteristic of each character in the type of sequential codes.

17. The electronic device according to claim 16, wherein the electronic device further comprises a first setting interface and a second setting interface, where the first setting interface is configured to set the total number of the characters of the sequential codes, and the second setting interface is configured to set the characteristic of each character of the sequential codes.

18. The electronic device according to claim 11, wherein the determining step comprises:
comparing each character of the first sequential code with the recognition rule to determine whether the first sequential code matches with the recognition rule of the type of sequential codes.

19. The electronic device according to claim 18, wherein when the characteristic of each character of the first sequential code matches with the recognition rule, the first sequential code is determined to match with the recognition rule; and when the characteristic of any character of the first sequential code does not match with the recognition rule, the first sequential code is determined to not match with the recognition rule.

20. The electronic device according to claim 11, wherein when a character of the first sequential code is a letter which does not match with the recognition rule, the letter is corrected into a predetermined number which is similar shaped with the letter; and when a character of the first sequential code is a number which does not match with the recognition rule, the number is corrected into a predetermined letter which is similar shaped with the number.
